(19) United States
(12) Patent Application Publication
(10) Pub. No.: US 2024/0072458 A1
(43) Pub. Date: Feb. 29, 2024

(54) CONDUCTOR TERMINAL

(71) Applicant: WAGO Verwaltungsgesellschaft mbH, Minden (DE)

(72) Inventors: Carsten LUDEWIG, Lauenhagen (DE); Christian ARNDT, Bielefeld (DE)

(73) Assignee: WAGO Verwaltungsgesellschaft mbH, Minden (DE)

(21) Appl. No.: 18/239,794

(22) Filed: Aug. 30, 2023

(30) Foreign Application Priority Data
Aug. 31, 2022 (DE) 20 2022 104 917.3

(51) Int. Cl. H01R 4/48

(52) U.S. Cl. CPC H01R 4/48365; H01R 4/48455

(57) ABSTRACT

A conductor terminal, including a spring-force clamping connection for clamping an electrical conductor via spring force. The spring-force clamping connection having a clamping spring, which includes a clamping leg for clamping the electrical conductor on a clamping surface, a spring bend, and a contact leg for fastening and supporting the clamping spring against a clamping force applied by the clamping leg to the electrical conductor. The clamping leg being connected to the contact leg via the spring bend, and the contact leg being fixed to a holder. An actuating area deflects the clamping leg by manually actuating the actuating area. The clamping leg extending from the spring bend to a free end of the clamping spring in a longitudinal direction, and the actuating area being arranged eccentrically to the clamping leg in a width direction of the clamping leg which is orthogonal to the longitudinal direction.

This nonprovisional application claims priority under 35 U.S.C. § 119(a) to German Patent Application No. 20 2022 104 917.3, which was filed in Germany on Aug. 31, 2022, and which is herein incorporated by reference.

### BACKGROUND OF THE INVENTION

### Field of the Invention

The invention relates to a conductor terminal, including a spring-force clamping connection for clamping an electrical conductor by means of spring force, the spring-force clamping connection having a clamping spring, which includes a clamping leg for clamping the electrical conductor on a clamping surface, a spring bend, and a contact leg for fastening and supporting the clamping spring against a clamping force applied by the clamping leg to the electrical conductor, the clamping leg being connected to the contact leg via the spring bend, and the contact leg being fixed to a holder, the clamping spring having an actuating area, which is designed to deflect the clamping leg by manually actuating the actuating area, the clamping leg extending from the spring bend to a free end of the clamping spring in a longitudinal direction, and the actuating area being arranged eccentrically to the clamping leg in a width direction of the clamping leg, which is orthogonal to the longitudinal direction.

### Description of the Background Art

Clamping springs having an asymmetrical actuation of this type are used, for example, in series 750 I/O modules of the applicant. A torsion of parts of the clamping spring may occur during the asymmetrical actuation, which may result in an inclined position of the clamping section of the clamping leg.

### SUMMARY OF THE INVENTION

It is therefore an object of the invention to provide an improved conductor terminal, in which the aforementioned effects are minimized.

In an example, this object is achieved for a conductor terminal of the type mentioned at the outset in that the holder has a contact edge for contact with the contact leg, the contact leg abutting a contact projection of the contact edge at only one point at least in an unactuated position of the clamping spring; and/or the clamping spring has an embossed bead.

The invention has the advantage that the effects of the asymmetrical actuation are minimized by each of the aforementioned features. The advantages of the asymmetrical actuation of the clamping spring may be retained, for example a particularly compact design of the conductor terminal. In particular, conductor terminal modules having a multiplicity of individual spring-force clamping connections arranged next to each other may be provided with a particularly compact design, because existing installation spaces may be optimally utilized.

In particular, an approximate force equilibrium during the actuation of the clamping spring may be established by feature a). Although an asymmetrical deformation occurs, and thus a twisting of the clamping spring, the contact leg is provided with a free space, during the actuation, in which it may rotate, due to the only single-point contact of the contact leg with the contact projection. In the non-deflected position (unactuated position) of the clamping spring, in particular, the clamping section may abut the clamping surface with the clamping edge over the entire length of the clamping edge. The contact leg, on the other hand, abuts only the contact projection of the contact edge facing the clamping surface on a single-point support. During the actuation/deflection of the clamping leg, the contact leg now has the ability, and in particular the free space, to rotate, while the clamping section or the clamping edge remains oriented in parallel to the clamping surface.

As a result, when resting on the clamping surface, the clamping edge and the contact edge of the holder may not be oriented in parallel to each other, e.g., skewed in relation to each other.

An inclined position of the clamping leg is avoided to the greatest possible extent. This permits a secure insertion and removal of electrical conductors, in particular wire end ferrules and conductors with large conductor cross-sections, since the cross-section of, for example, a conductor insertion channel of a housing is at least almost completely unblocked for the insertion or removal of the conductor and is not restricted by an inclined clamping leg. The conductor insertion channel is uniformly unblocked to the greatest possible extent in this manner.

The clamping spring may be additionally stiffened and the twisting of the clamping spring minimized during the actuation by the bead embossed into the clamping spring.

In particular, the center of the actuating area may be arranged so as to be offset in relation to the center of the clamping leg in the width direction. In particular, only a one-sided actuating area may be present on the clamping leg. A deformation of the clamping spring during a deflection of the clamping leg for the purpose of opening the clamping point may take place predominantly in the spring bend. The actuating area is preferably not formed on the spring bend but rather in the part of the clamping spring including the clamping leg. The actuating area may have a distance from the spring bend in the longitudinal direction. The actuating area may be designed, in particular, as an area of the clamping leg provided for the actuation.

The conductor terminal can include a busbar, on which the clamping surface for clamping the electrical conductor can be formed. A reliable power transmission in the conductor terminal is made possible by a busbar of this type.

The holder, to which the contact leg is fixed, can be designed as part of the busbar or a component connected to the busbar. This has the advantage that a self-supporting contact insert may be formed by the clamping spring and the busbar, in which the forces of the clamping spring are conducted away via the busbar. Stresses of other parts may be avoided thereby, for example parts of a housing of the conductor terminal.

The busbar can have at least one area, U-shaped in cross-section, the clamping surface being formed on a leg of the U-shaped area, and the holder being formed on the other leg of the U-shaped area which is essentially in parallel thereto. Due to a U-shaped area of this type, the busbar forms a kind of receiving chamber or receiving cage for receiving the clamping spring.

The contact leg can be fixed to the holder at an oblique angle α with respect to the clamping surface, at least in an actuated position of the clamping spring. When the clamping spring is actuated, the contact leg may thus execute a torsional movement, by means of which it is oriented at the oblique angle with respect to the clamping surface. In particular, the contact leg may abut the contact edge not only at a single point in this actuated state of the clamping spring. The contact edge may run at an oblique angle. e.g., angle α or a larger angle, in relation to the clamping surface.

The contact leg can be fixed to the holder at an oblique angle in the range of 2° to 20° with respect to the clamping surface, at least in an actuated position of the clamping spring. Accordingly, the contact leg is only relatively moderately inclined.

The contact edge can run at the angle at which the contact leg is obliquely fixed to the holder with respect to the clamping surface. In this way, disadvantageous effects of the twisting of the clamping spring may be largely compensated for by the inclined position of the contact leg. The holder may have a slot-shaped receptacle for receiving the contact leg, the contact edge then being formed on the inside of the slot-shaped receptacle.

The bead can extend over a part of the contact leg and a part of the spring bend in its longitudinal direction, in particular over the predominant part of the spring bend. The bead may therefore be designed as an elongated bead, i.e., as a bead which has a significantly greater length than width. The width of the bead is measured in the aforementioned width direction. The bead may be designed as a bead running in a straight line. The bead may be embossed into the clamping spring from the inside of the space surrounding the contact leg, the spring bend, and the clamping leg.

The bead can be embossed in the width direction on the side of the clamping spring on which the actuating area is situated. In this way, the stiffening effect of the bead may be further optimized to compensate for the torsion of the clamping spring.

The clamping leg can protrude over the edge of the spring bend in the width direction on at least one side. For example, the clamping leg may protrude over the edge of the spring bend on the side facing away from the actuating area. In this way, a relatively wide clamping section may be provided. For example, the clamping leg may protrude over the edge of the spring bend by an amount corresponding to at least 10% of the length of the clamping edge of the clamping leg.

The clamping leg can have a clamping section for striking the electrical conductor in a clamping manner on a free end in the longitudinal direction. This permits a secure clamping of an electrical conductor. The clamping section may have, for example, a clamping edge which may dig slightly into the electrical conductor during the fixed clamping thereof. A clamping point for clamping the electrical conductor is then formed between the clamping section and the clamping surface of the busbar.

The clamping leg may thus extend in its longitudinal direction from the spring bend to a free end of the clamping leg of the clamping spring, e.g., to the clamping section.

The actuating area can be arranged laterally next to the clamping section in the width direction. In this way, the clamping spring may be provided with a particularly compact and space-saving design. A particularly efficient actuation of the clamping leg by manually striking the actuating area is also possible, because the force introduced by the manual actuation may engage in the direct vicinity of the clamping section.

The clamping section can extend to a side edge of the clamping leg in the width direction. In this way, the widest possible clamping section is provided, so that electrical conductors having a comparatively large cross-section may also be clamped. The clamping section may directly abut the actuating area in the width direction. The actuating area may extend to the opposite side edge in the width direction, i.e., the side edge facing away from the clamping section.

The manual actuation of the of actuating area of the clamping leg may be carried out, for example, with the aid of an external tool, which is not part of the conductor terminal, e.g., with the aid of a screwdriver.

The conductor terminal can include a manual actuating element, with the aid of which the clamping leg may be deflected by means of actuation at the actuating area for the purpose of opening the clamping point. This has the advantage that the conductor terminal itself already has an actuating element of this type, so that the manual actuation of the clamping leg may take place easily and securely, and an external tool is not necessarily required for this purpose. In one advantageous embodiment of the invention, the manual actuating element is designed and arranged in such a way that, during a manual actuation of the actuating element, the latter strikes the actuating area of the clamping spring at an effective point arranged eccentrically to the clamping leg in the width direction of the clamping leg. The asymmetrical actuation by the actuating element mentioned at the outset is thus implemented. In one practical design of the conductor terminal, the aforementioned effective point is generally not a point in the mathematical sense but a locally delimited subarea of the actuating area. Within the meaning of the present description, the surface center of gravity of the subarea is viewed as the effective point, upon which the actuating element acts upon the actuating area, or with which the actuating element interacts on the actuating area.

The clamping section of the clamping leg can run essentially in parallel to the clamping surface when the clamping leg is deflected by the actuating element, and the actuating element is in its end position. In this way, the undesirable twisting of the clamping leg and the inclined position may be largely minimized or the twisting correspondingly counteracted.

The contact edge for contacting the contact leg can be designed to ascend in the direction of the actuating element. Or, in other words, the contact edge approaches, in the direction of the actuating element, a leg of a U-shaped busbar having the clamping surface.

The actuating element can be movably supported and guided in a plane of motion, the actuating element having an actuating projection which protrudes transversely to the plane of motion and/or in the width direction and is designed to strike the actuating area when the actuating element is actuated manually. The construction of a compact conductor terminal is also promoted hereby, because the actuating element may be arranged laterally next to the clamping spring in a space-saving manner and may reliably actuate the clamping spring via the laterally protruding actuating projection.

The actuating element may have an actuating projection protruding on only one side and thus be provided with an asymmetrical design in relation to the plane of motion. For example, the actuating element may have a main body, on which, on a side accessible to the user of the conductor terminal, a manual control section is present, on which the user may apply an actuating force to the actuating element. The actuating projection may be arranged at a point of the main body situated at a distance from the control section and protrude to the side, i.e., transversely to the actuating plane.

The conductor terminal may have a housing. The actuating element may be supported and guided on parts of the housing. Alternatively, or additionally, the actuating element may also be supported and guided on parts of a contact insert of the conductor terminal, for example on a busbar and/or on the clamping spring. The housing may have a conductor insertion channel for the defined insertion of an electrical conductor up to the clamping point. A conductor insertion direction is defined by the conductor insertion channel, for example the center line of the conductor insertion channel, in which the electrical conductor is to be inserted into the housing. The conductor insertion direction may be oriented, for example, in parallel to the plane of motion, in which the actuating element is movably supported and guided.

The actuating element may be designed as a pivotable actuating lever. In this case, the plane of motion is the pivot plane of the actuating lever. The actuating element may also be designed as a displaceable pushbutton. In this case, the plane of motion is defined by the displacement direction of the pushbutton and a guide channel, in which the pushbutton is guided.

A surface of the actuating projection which does not abut the clamping spring and is oriented predominately in the width direction and/or a surface of another part of the actuating element can run at an angle, i.e., at an oblique angle, to the plane of motion, e.g., at an angle of 10 to 40 degrees. In this way, the actuating element may be provided with a comparatively narrow design, and the introduction of the actuating force onto the actuating area may still be placed as a far as possible toward the center of the clamping spring. The tendency of the clamping spring to twist during actuation may be reduced hereby. The actuating element may also be accommodated in a space-saving manner. The entire surface oriented predominantly in the width direction does not necessarily have to have this inclined arrangement, but rather at least one subarea of the surface situated at a distance from the edges of the actuating projection, i.e., not only one chamfer may be present at the edges. In addition, the inclined surface of the actuating projection may also be used to guide the conductor and/or support the conductor guidance.

For example, a surface arranged at an oblique angle may additionally be present on the main body. The surface of the main body arranged at the oblique angle and the surfaces of the actuating projection may run, for example, in parallel to each other. The surfaces running at an oblique angle to the plane of motion may be a planar surface or an arched surface, for example a concavely arched surface.

The spring bend can extend over an angle range of at least 45°, or at least 120°, or at least 150°, or at least 170°. During an actuation of the clamping spring to open to clamping point, the resulting deformation of the clamping spring is carried out predominantly by the spring bend.

The clamping leg may extend beyond the contact leg on one or both edge sides in the width direction. In particular, the clamping section may extend beyond the contact leg in the width direction. The actuating area may extend beyond the contact leg in the width direction.

The clamping leg may have a bent contour in the longitudinal section, for example with a bending area arranged at a distance from the free end of the clamping leg in the range of 30% to 70% of the length thereof in the longitudinal direction. The bending area may be bent in a bending direction opposite the spring bend. The bending area may extend over an angle range of more than 30° and/or less than 90°.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view of an actuating element and a contact insert of a conductor terminal;

FIG. 2 shows the contact insert according to FIG. 1 viewed in a different direction;

FIG. 3 shows a side view of the actuating element and the contact insert according to FIG. 1;

FIG. 4 shows a side cross-sectional view of a conductor terminal. which contains the contact insert according to FIG. 1;

FIGS. 5 and 6 show a clamping spring in different perspective views;

FIG. 7 shows a top view of a holder of the clamping spring; and

FIG. 8 shows a top view of a holder including the clamping spring.

### DETAILED DESCRIPTION

FIG. 1 shows, as parts of a conductor terminal, a contact insert 3, 4 and an actuating element 5, which is designed in the form of a pushbutton supported in an essentially linearly movable manner. Contact insert 3, 4 includes a busbar 3 and a clamping spring 4.

Clamping spring 4 has a clamping leg 43, a spring bend 42, and a contact leg 41. Clamping leg 43 is used to clamp an electrical conductor at a clamping point. The clamping point in this case is formed by a free end of clamping leg 43 in connection with a clamping surface 30 of busbar 3. An electrical conductor is pressed and clamped against clamping surface 30 by clamping leg 43.

Clamping leg 43 is connected to contact leg 41 via spring bend 42. Contact leg 41 is used to fasten clamping spring 4 as well as to support clamping spring 4 against the clamping force applied by clamping leg 43 to the electrical conductor. For example, contact leg 41 may have a fixing element 40, for example a clip protruding in the longitudinal direction, with the aid of which contact leg 41 is fastened to a part of busbar 3, e.g., on a holder 31.

An actuating area 46 is present on clamping leg 43. which is used to deflect clamping leg 43 by the manual actuation of actuating area 46 for the purpose of opening the clamping point. Clamping leg 43 is moved away from clamping surface 30 of busbar 3 so that an electrical conductor may be removed therefrom or placed there without any application of force. The deformation of clamping spring 4 which occurs during this deflection of clamping leg 43 is carried out predominantly by spring bend 42. As is apparent, clamping leg 43 may itself also have a bend, e.g., over a bending area 47. This bending area 47, however, does not form a spring bend of clamping spring 4, in particular it does not undertake the predominant deformation of the clamping spring during the deflection of clamping leg 43. Bending area 47 may be bent in a bending direction opposite spring bend 42.

Clamping leg 43 extends from spring bend 42 to a free end of clamping spring 4 at clamping leg 43 in a longitudinal direction L. Actuating area 46 is arranged eccentrically on clamping leg 43 in a width direction B of clamping leg 43, which is orthogonal to longitudinal direction L. Clamping leg 43 has a clamping section 44 on the free end in longitudinal direction L for striking the electrical conductor in a clamping manner. Clamping section 44 thus forms a clamping area of clamping spring 4. It is apparent that actuating area 46 is arranged to the side of clamping leg 43, i.e., not in the center in the width direction, but rather slightly eccentrically laterally next to clamping section 44. This results in an asymmetrically application of force of clamping leg 43 during an actuation by actuating element 5.

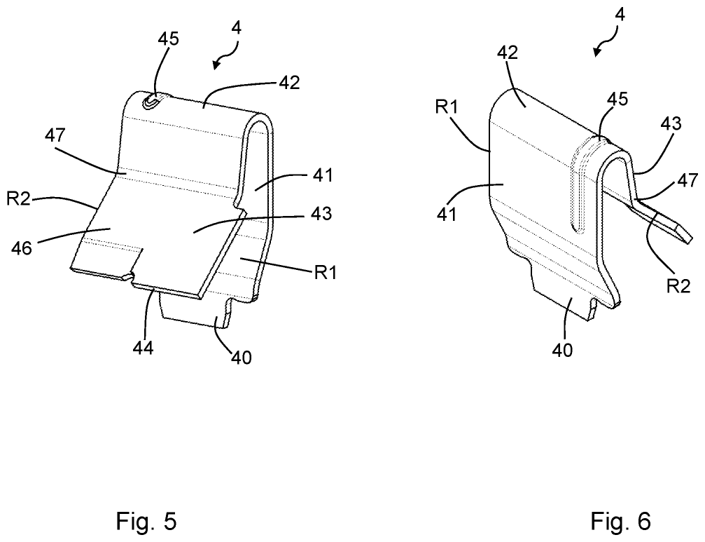

Clamping spring 4 has an edge side R1, apparent in FIG. 1, as well as a diametrically opposed edge side R2, which is arranged in a concealed manner based on the illustration in FIG. 1 (cf. FIGS. 5 though 6). In clamping spring 4, clamping leg 43 undergoes a uniform transition into spring bend 42 at edge side R1, i.e., without an indentation or convexity or, as is apparent in FIG. 5, via a shoulder. Over the further profile, spring bend 42 transitions into contact leg 41 at edge side R1 without an indentation or convexity.

Actuating element 5 has a main body 51, on which, in an area accessible to the user, e.g., at one end, a manual control section 50 may be present, on which the user may apply an actuating force to actuating element 5. An actuating projection 52, which protrudes transversely to actuation direction D of actuating element 5 and which is used to strike actuating area 46 when actuating element 5 is actuated manually, is also arranged on main body 51 on the side oriented in the direction of clamping leg 43.

For the defined guidance of actuating element 5 and to limit its freedom of movement, the latter may have, for example, a side guiding surface 56, which is used for guidance during a displacement movement of actuating element 5. For example, side guiding surface 56 may be guided along a part of busbar 3 or along a part of a housing of the conductor terminal. In addition, a depth stop 55 may be formed on actuating element 5, which is used to limit the maximum actuation distance. Upon reaching the maximum actuation distance, for example, depth stop 55 may strike a part of the housing of the conductor terminal or a part of contact insert 3, 4. for example on busbar 3.

A surface 53 of actuating projection 52 oriented in the direction of edge side R1 of clamping spring 4 or another surface 54 of main body 51 oriented in this direction may be arranged at an incline to actuation direction D of actuating element 5. This is even more clearly apparent, for example, in FIG. 4.

As is also apparent in FIG. 1, busbar 3 is provided with a U-shaped design in cross-section at least in a certain area. Clamping surface 30 is situated on a leg of the U-shaped area. Holder 31 for holding contact leg 41 of clamping spring 4 is situated on another leg of the U-shaped area essentially in parallel thereto. Clamping spring 4 is fixed to holder 31 with the aid of fixing element 40 of contact leg 41.

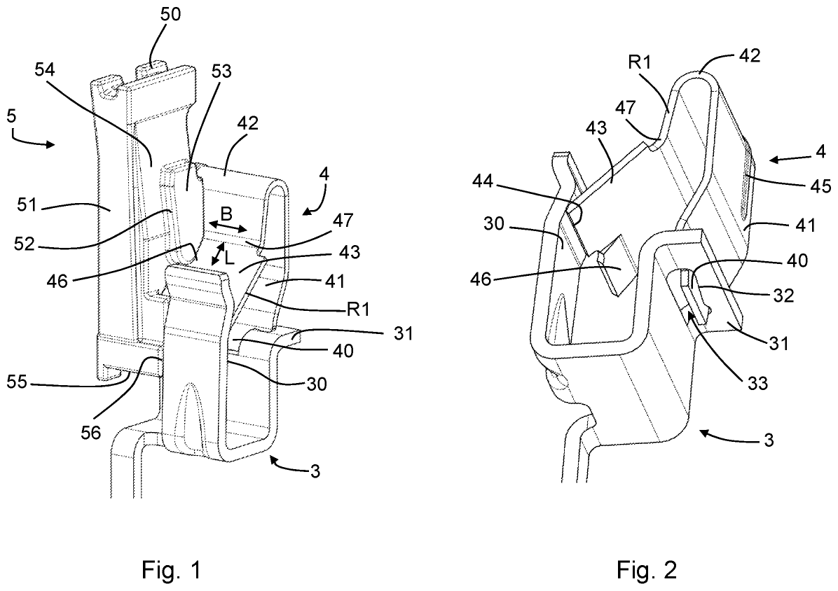

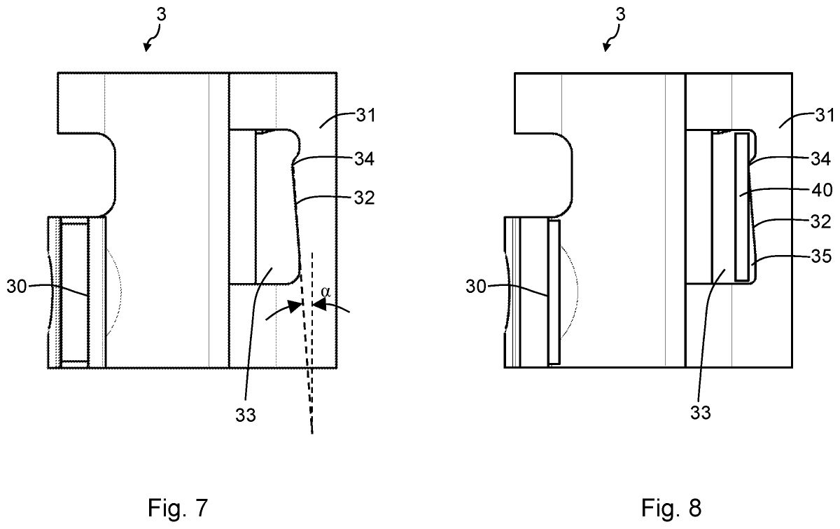

FIG. 2 shows the arrangement of clamping spring 4 on busbar 3, viewed in a different direction. It is apparent, in particular, that holder 31 has a slot-shaped receptacle 33 for receiving fixing element 40. A contact edge 32, which runs at an oblique angle to clamping surface 30, is formed in slot-shaped receptacle 33. Contact leg 41 is fixed to holder 31 in this location. End-side clamping section 44 arranged on clamping leg 43 is oriented thereby essentially in parallel to clamping surface 30, in particular even when clamping leg 43 is deflected to the maximum extent by actuating element 5. The torsion of the clamping spring induced by the one-sided actuation of clamping spring 4 is compensated for in this manner. The special features of the fixing of contact leg 41 to holder 31 are explained in greater detail below based on FIGS. 7 and 8.

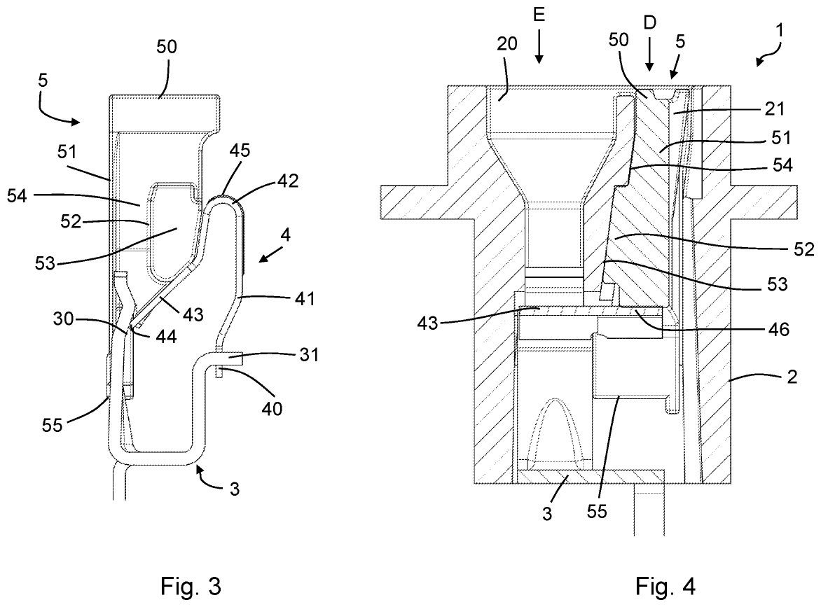

FIG. 3 shows a side view of the arrangement according to FIG. 1. For example, the fastening of contact leg 41 to holder 31 with the aid of fixing element 40 is clearly apparent.

A conductor terminal 1, which includes a housing 2, is illustrated in FIG. 4. An arrangement of a contact insert 3, 4 and actuating element 5 according to FIG. 1 is provided in housing 2. Housing 2 has a conductor insertion channel 20. An electrical conductor to be clamped at the clamping point must be inserted through conductor insertion channel 20 in a conductor insertion direction E and in this way is guided to the clamping point in a targeted manner. Housing 2 also includes a pushbutton guide channel 21, in which actuating element 5 is arranged and displaceably supported in actuation direction D.

It is apparent that surfaces 53, 54 of actuating element 5 run at an oblique angle to conductor insertion direction E. Actuating element 5 may be provided with a relatively narrow design hereby and therefore be accommodated in housing 2 in a space-saving manner. Due to the inclined position of at least actuating projection 52, the introduction of the actuation force may be shifted as far as possible to the center of the clamping spring, i.e., the effective point at which actuating element 5 acts upon actuating area 46 of clamping spring 4 may be arranged at least centrally in relation to spring bend 42 with respect to the narrowest point of spring bend 42. Conductor insertion direction E may run in parallel to actuation direction D of actuating element 5.

FIGS. 5 and 6 show a clamping spring 4, which may be used for conductor terminal 1 described above. Clamping spring 4 has the features already described above. It is also apparent that a bead 45 is embossed in an area of clamping spring 4. Bead 45 is embossed from the inside, so that the material of bead 45 protrudes slightly to the outside. It is also apparent in FIG. 3 that bead 45 may extend in its longitudinal direction over a part of contact leg 41 and a part of spring bend 42. It is further apparent that clamping leg 43 may be provided with a slotted design between clamping section 44 and actuating area 46, starting from the free end of clamping leg 43. A section of actuating area 46 situated on the free end of clamping leg 43 may thus be bent with respect to clamping section 43. Actuating area 46 may be further optimized thereby.

FIG. 7 shows busbar 3 in a view directed into the U-shaped area. In this viewing direction, the inclined position of contact edge 32 by an angle α relative to clamping surface 30 is clearly apparent. FIG. 8 shows busbar 3 in the same view as in FIG. 7, contact leg 41 or its fixing element 40 being additionally apparent. It is apparent that contact edge 32 does not extend over the entire longitudinal extension of slot-shaped receptacle 33 but ends at a contact projection 34 and follows a recess in its further profile. Contact projection 34 thus forms the section of contact edge 32 closest to clamping surface 30. It is apparent that contact leg 41 abuts contact projection 34 at a single point with fixing element 40, i.e., in the manner of a single-point support. In the remaining area of contact edge 32, a free space 35 is present between contact edge 32 and contact leg 41, at least in the actuating state of clamping spring 4 illustrated in FIG. 8. If the clamping spring is now actuated, i.e., if the clamping leg is deflected in the direction of the contact leg, the clamping spring twists, which results in the fact that contact leg 41 undergoes a torsional movement into free space 35 and may ultimately come to rest over a wide area on contact edge 32. Contact edge 32 at least limits the maximum pivoting movement of contact leg 41 within slot-shaped receptacle 33.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor terminal comprising:
a spring-force clamping connection to clamp an electrical conductor via a spring force, the spring-force clamping connection comprising:
a holder;
a clamping spring comprising a clamping leg for clamping the electrical conductor on a clamping surface, a spring bend, and a contact leg for fastening and supporting the clamping spring against a clamping force applied by the clamping leg to the electrical conductor, the clamping leg being connected to the contact leg via the spring bend, and the contact leg being fixed to the holder; and
an actuation area formed on the clamping spring, the actuating area adapted to deflect the clamping leg by manually actuating the actuating area, the clamping leg extending from the spring bend to a free end of the clamping spring in a longitudinal direction, and the actuating area being arranged eccentrically to the clamping leg in a width direction of the clamping leg, which is orthogonal to the longitudinal direction,
wherein the holder has a contact edge for contact with the contact leg, the contact leg abutting a contact projection of the contact edge at only one point at least in an unactuated position of the clamping spring and/or wherein the clamping spring has an embossed bead.

2. The conductor terminal according to claim 1, wherein the conductor terminal comprises a busbar, on which the clamping surface for clamping the electrical conductor is formed.

3. The conductor terminal according to claim 2, wherein the holder, to which the contact leg is fixed, is designed as part of the busbar or a component connected to the busbar.

4. The conductor terminal according to claim 1, wherein the busbar has at least one area, U-shaped in cross-section, the clamping surface being formed on a leg of the U-shaped area, and the holder being formed on the other leg of the U-shaped area which is essentially in parallel thereto.

5. The conductor terminal according to claim 1, wherein the contact leg is fixed to the holder at an oblique angle to the clamping surface, at least in an actuated position of the clamping spring or at an angle in a range from 2° to 20°.

6. The conductor terminal according to claim 5, wherein the contact edge runs at the angle at which the contact leg is fastened to the holder at an incline to the clamping surface.

7. The conductor terminal according to claim 1, wherein the bead extends over a part of the contact leg and a part of the spring bend in its longitudinal direction or over the predominant part of the spring bend.

8. The conductor terminal according to claim 1, wherein the bead is embossed in the width direction on a side of the clamping spring on which the actuating area is situated.

9. The conductor terminal according to claim 1, wherein the clamping leg protrudes over the edge of the spring bend in a width direction on at least one side.

10. The conductor terminal according to claim 1, wherein the clamping leg has a clamping section on a free end in the longitudinal direction for striking the electrical conductor in a clamping manner.

11. The conductor terminal according to claim 10, wherein the actuating area is arranged laterally next to the clamping section in the width direction.

12. The conductor terminal according to claim 10, wherein the clamping section extends to or towards a side edge of the clamping leg in the width direction.

13. The conductor terminal according to claim 1, wherein the conductor terminal includes a manual actuating element, with the aid of which the clamping leg is adapted to be deflected via actuation at the actuating area to open the clamping point.

14. The conductor terminal according to claim 13, wherein the clamping section of the clamping leg runs essentially in parallel to the clamping surface when the clamping leg is deflected by the actuating element and the actuating element is in its end position.

15. The conductor terminal according to claim 13, wherein the contact edge is designed to ascend in the direction of the actuating element to contact the contact leg (41).

16. The conductor terminal according to claim 13, wherein the actuating element is movable supported and guided in a plane of motion, the actuating element having an actuating projection which protrudes transversely to the plane of motion and/or in the width direction and is designed to strike the actuating area when the actuating element is actuated manually.

17. The conductor terminal according to claim 13, wherein the conductor terminal includes, as the actuating element, a lever arranged and/or supported in the housing and/or a pushbutton having an actuating section for manually actuating the actuating area.

18. The conductor terminal according to claim 1, wherein the actuating area is formed eccentrically to the clamping leg and the actuating area on exactly one side of the clamping leg in the width direction.

19. The conductor terminal according to claim 1, wherein the spring bend extends over an angle range of at least 45°, or at least 120°, or at least 170°.
